(19) United States
(12) Patent Application Publication
(10) Pub. No.: US 2020/0276670 A1
(43) Pub. Date: Sep. 3, 2020

(54) ORIGINAL SHEET DIVIDING METHOD AND DIVIDING MECHANISM AND DIVIDING APPARATUS THEREFOR

(71) Applicant: O. M. C. CO., LTD., Takatsuki-shi, Osaka (JP)

(72) Inventor: Shinji WATANABE, Takatsuki-shi, Osaka (JP)

(21) Appl. No.: 16/068,040

(22) PCT Filed: Jan. 6, 2016
(86) PCT No.: PCT/JP2016/000042

§ 371 Date: Jul. 3, 2018

(51) Int. Cl. B23K 26/38; B23K 26/08; B23K 37/04; B21D 43/04

(52) U.S. Cl. CPC B23K 26/38; B23K 26/08; B23K 2101/18; B23K 37/0408; B21D 43/04; B23K 26/0853

(57) ABSTRACT

Provided is an epoch-making original sheet dividing method in which an original sheet is cut while being conveyed and which enables a continuous operation to be performed for a long period of time without occurrence of burrs at cut end faces, without scattering cutting dust, and without time and effort for component replacement.

The original sheet dividing method is an original sheet dividing method for cutting an original sheet 1 having an active material layer applied to at least one surface of a long metal foil 4, with a laser beam L in a longitudinal direction. The original sheet 1 is continuously moved. While the original sheet 1 is moved, the laser beam L is applied to the original sheet 1 to melt the original sheet 1 at an irradiation point P. At a downstream side of the irradiation point P of the laser beam L, one divided original sheet 1s is pulled upward relative to a feed surface of the original sheet 1, and adjacent another original sheet 1t is pulled downward relative to the feed surface of the original sheet 1, thereby separating the slit original sheets 1s and 1t adjacent to each other at the irradiation point P.

### TECHNICAL FIELD

The present invention relates to an epoch-making original sheet dividing method that enables an original sheet for producing an electrode sheet used in a lithium secondary battery, a lithium capacitor, an electric double layer capacitor, and the like, to be divided into a plurality of sections with a laser beam, while the original sheet is being moved, without dust during being cut and without occurrence of burrs at cut end faces, and a dividing mechanism and a dividing apparatus therefor.

### BACKGROUND ART

Nonaqueous electrolytic solution secondary batteries typified by lithium ion secondary batteries have been used in small electric apparatuses such as mobile phones and personal computers and in various large electric components such as electrical storage devices of hybrid or electric vehicles, since these secondary batteries have the merit of having a high energy density. Electrode assemblies that are main internal structures of lithium ion secondary batteries include a wound type in which a separator and positive and negative electrode bands each having an active material applied to a metal foil are stacked and wound, and a lamination type in which separators and positive and negative electrode sheets each obtained by cutting an original sheet into a rectangular shape are alternately laminated. The above structures are also the same in lithium capacitors and electric double layer capacitors.

These electrode assemblies are configured according to the sizes of electric components to be used. Meanwhile, an original sheet that is a raw material for the electrode assemblies includes: an electrode portion in which a positive or negative active material is applied to one surface or both surfaces of a wide metal foil such as aluminum or copper over the substantially entire width, in the form of a band, and in a longitudinal direction in terms of productivity; and non-electrode portions (referred to as ear portions) that are provided at both sides of the electrode portion and in which no active material is applied. In general, the original sheet is wound in the form of a roll.

A conventional dividing apparatus slits a wide original sheet into a required width according to use, for example, with a slitter having a pair of upper and lower disc-shaped blades (Patent Literature 1).

However, when the conventional dividing apparatus slits, with the disc-shaped slitter blades, an original sheet on which a hard active material is applied, the cutting edges of the blades is gradually worn by the hard active material, so that sharp burrs easily occur at cut end faces, that is, on the surface of the original sheet, in the cutting direction. Regarding such a defect, the following problems have been pointed out.

When the above slit narrow original sheet is used to produce a wound type assembly in which a separator and positive and negative electrode bands are stacked and wound or a lamination type assembly in which separators and positive and negative electrode sheets each obtained by cutting an original sheet into a rectangular shape are alternately laminated, and the produced assembly is used as an electrode assembly of a secondary battery, the battery slightly and repeatedly expands and contracts, due to charging and discharging, to slightly and gradually increase the volume thereof. Thus, the burrs may repeatedly damage the separator, which is an insulating film, to cause flaws thereon to grow, or the burrs may grow, due to the above charging and discharging, to break through the separator to cause insulation breakdown, which causes trouble.

In addition to the above, in the case of cutting with blades, the conventional dividing apparatus requires periodical maintenance because of the wear as described above, and the apparatus has to be stopped for replacing the blades each time maintenance is performed, which becomes an obstacle to improvement of productivity.

As a solution to such problems, use of a laser beam has been proposed. In the case of cutting an original sheet by applying a laser beam to the original sheet while the original sheet is being moved, an irradiation spot of the laser beam moves on a cutting line. At the irradiation spot, the original sheet instantaneously melts in a small range. Then, when the irradiation spot has moved from one point on the cutting line to the next irradiation position, the previous melting portion instantaneously becomes solidified due to its heat being taken by the surroundings, so that the cut portion becomes rejoined. As a result, the original sheet is not sufficiently cut, and its appearance is similar to that in the case where the laser beam merely runs over the original sheet.

Therefore, in order to avoid the rejoining due to the solidification, the conventional dividing apparatus using a laser beam is configured to spray high-pressure assist air to the irradiation spot of the laser beam to instantaneously blow away the melting material (Non-Patent Literature 1).

Accordingly, in the case of laser cutting, in order to avoid the rejoining due to the solidification, the high-pressure assist air is sprayed to the irradiation spot of the laser beam to instantaneously blow away the melting material.

As described above, in the case of spraying the high-pressure assist air to the irradiation spot of the laser beam to instantaneously blow away the melting material, the blown-away melting material scatters as fine particles to the surrounding area to adhere to the original sheet. When the above electronic component is produced by using the original sheet to which the fine particles have adhered, the adhering particles break the separator of the assembly during use of the electronic component to cause insulation breakdown, causing the same trouble as with the burrs.

This point also applies to the case of suction. When the original sheet is perforated with the laser beam, air is immediately sucked from the hole toward a suction hole at the back side of the original sheet. At this time, the material that is melted during cutting is entrained in the air and sucked into the suction hole. However, an external force in the suction direction is momentarily applied to the melting material at start of the suction, so that part of the material scatters as fine dust to the surrounding area to adhere to the original sheet, causing the above trouble.

### CITATION LIST

### Patent Literature

[PTL 1] Japanese Laid-Open Utility Model Publication No. 7-37595

[PTL 2] Japanese Laid-Open Patent Publication No. 2007-14993

### Non Patent Literature

[NPL 1] http://www.monozukuri.org/mono/db-dmrc/laser-cut/kiso/

### SUMMARY OF INVENTION

### Technical Problem

In the invention of cited literature 2, a focal length or the effective aperture of a condensing lens is set to a predetermined condition, and an original sheet that is being continuously fed is cut with a laser beam. However, as described above, the original sheet cannot be cut only with the laser beam. Thus, assist gas has to be used as disclosed in Non-Patent Literature 1. With this method, cutting dust scatters to the surrounding area as described above.

An object of the present invention is to provide a method that enables an original sheet to be divided without scattering cutting dust, unlike such conventional art, and a dividing mechanism and a dividing apparatus therefor.

### Solution to Problem

An invention method recited in claim 1 is an original sheet dividing method for cutting an original sheet 1 having an active material layer applied to at least one surface of a long metal foil 4, with a laser beam L in a longitudinal direction, the original sheet dividing method including:
continuously moving the original sheet 1 while applying the laser beam L to the original sheet 1 to melt the original sheet 1 at an irradiation point P;
causing a moving direction of one divided original sheet 1s to be upward or downward relative to a moving direction of another divided original sheet 1t at a downstream side of the irradiation point P; and
vertically separating the divided original sheets 1s and 1t adjacent to each other at the irradiation point P.

The above case includes a case where the moving direction of the other original sheet 1t agrees with the moving direction of the original sheet 1 before division and only the moving direction of the one divided original sheet 1s is caused to be upward or downward relative to the moving direction of the other original sheet 1t, and a case where the one divided original sheet 1s is moved upward relative to the moving direction of the original sheet 1 before division and the other original sheet 1t is moved downward relative to the moving direction of the original sheet 1 before division. A separation angle θ occurs between the original sheets 1s and 1t.

Accordingly, a maintenance-free continuous operation is enabled to be performed, and the original sheet 1 can be assuredly divided at a high speed into a plurality of the narrow original sheets 1s and 1t with the laser beam L without occurrence of burrs at cut faces and without scattering cutting dust to the surrounding area.

In the invention method recited in claim 2, in claim 1, the original sheet 1 is cut while the laser beam L is caused to reciprocate along a running direction of the original sheet 1.

While the laser beam L moves in the same direction as the original sheet 1, the relative moving speed of the laser beam L to the original sheet 1 decreases, so that irradiation energy per unit time increases. As a result, the original sheet 1 is cut deeply.

On the other hand, while the laser beam L moves in a direction opposite to that of the original sheet 1, the relative moving speed of the laser beam L to the original sheet 1 increases, so that the irradiation energy per unit time decreases. Accordingly, a melting material adhering to a cut portion is heated by the laser beam L to be rounded, and the cut portion is finished with a clean cut face. In this case, output of the laser beam L is adjusted such that the original sheet 1 is divided as a result of a plurality of times of reciprocation of the laser beam L.

In the invention method recited in claim 3, in claim 1 or 2,
a separating member 40 is disposed at the downstream side of the irradiation point P, and
the one divided original sheet 1s is caused to move over the separating member 40 or pass below the separating member 40 to make the moving direction of the one divided original sheet 1s different from the moving direction of the other original sheet 1t.

By using the separating member 40, assured division is enabled.

An invention recited in claim 4 is an original sheet dividing mechanism 110 for cutting a running original sheet 1 having an active material layer applied to at least one surface of a long metal foil 4, with a laser beam L in a longitudinal direction, the original sheet dividing mechanism 110 including:
a laser emission device 30 disposed above the original sheet 1 and configured to apply the laser beam L to the original sheet 1 to divide the original sheet 1; and
a separating member 40 disposed at a downstream side of an irradiation point P of the laser beam L so as to be in contact with a lower surface of one divided original sheet 1s and configured to raise the divided original sheet 1s, or disposed at the downstream side of the irradiation point P of the laser beam L so as to be in contact with an upper surface of another divided original sheet 1t and configured to press down the divided original sheet 1t, thereby to make a moving direction of the one divided original sheet 1s different from a moving direction of the other divided original sheet 1t.

Here, the separating member 40 includes two members, that is, a member configured to raise (press down) only the one divided original sheet 1s (1t) as shown in FIGS. 5 and 6, and a member configured to raise (press down) both divided original sheets 1s (1t) with a step therebetween as shown in FIGS. 7 and 8.

An invention recited in claim 5 is an original sheet dividing mechanism 110 for cutting a running original sheet 1 having an active material layer applied to at least one surface of a long metal foil 4, with a laser beam L in a longitudinal direction, the original sheet dividing mechanism 110 including:
a laser emission device 30 disposed above the original sheet 1 and configured to apply the laser beam L to the original sheet 1 to divide the original sheet 1; and
a separating member 40 including a raising-side member 40a disposed at a downstream side of an irradiation point P of the laser beam L so as to be in contact with a lower surface of one divided original sheet 1s and configured to raise the divided original sheet 1s and a pressing-side member 40b disposed at the downstream side of the irradiation point P of the laser beam L so as to be in contact with an upper surface of another divided original sheet 1t and configured to press down the divided original sheet 1t, the separating member 40 being configured to make a moving direction of the one divided original sheet 1s different from a moving direction of the other divided original sheet 1t.

In this case, as shown in FIGS. 1 to 4, the separating member 40 is configured to raise the one divided original sheet 1s and press down the other original sheet 1t. Here, the amount of the raising is equal to the amount of the pressing-down.

In the invention recited in claim 6, the separating member 40 of claim 4 or 5 is provided so as to move toward and away from the irradiation point P. Accordingly, the separation angle θ of the divided original sheets 1s and 1t adjacent to each other at the irradiation point P can be adjusted.

In the invention recited in claim 7, the separating member 40 of claim 4 or 5 is composed of a roller configured to rotate in contact with the divided original sheets 1s and 1t.

In the invention recited in claim 8, the separating member 40 of claim 4 or 5 is composed of a plate member having a cross-section parallel to a running direction of the original sheet 1, the cross-section having a thickness that gradually decreases as distance to an irradiation point P side decreases.

An invention recited in claim 9 is an original sheet dividing apparatus 100 for cutting a running original sheet 1 having an active material layer applied to at least one surface of a long metal foil 4, with a laser beam L in a longitudinal direction, the original sheet dividing apparatus 100 including:
an original sheet supply portion 10 configured to continuously feed the original sheet 1;
a laser emission device 30 disposed above the fed original sheet 1 and configured to apply the laser beam L to the original sheet 1 to divide the original sheet 1;
a separating member 40 disposed at a downstream side of an irradiation point P of the laser beam L so as to be in contact with a lower surface or an upper surface of at least one divided original sheet 1s (1t) and configured to raise or press down the divided original sheet 1s (1t) thereby to make a moving direction of the one divided original sheet 1s different from a moving direction of another divided original sheet 1t; and an original sheet take-up portion 60 disposed at a downstream side of the separating member 40 and configured to take up the divided original sheets 1s and 1t.

### Advantageous Effects of Invention

According to the present invention, the original sheet can be cut while being conveyed, and a continuous operation can be enabled to be performed without occurrence of burrs at cut end faces, without scattering cutting dust, and without time and effort for component replacement.

### BRIEF DESCRIPTION OF DRAWINGS

FIG. 1 is a perspective view of a first embodiment of an original sheet dividing apparatus according to the present invention.

FIG. 2 is an enlarged side view of a dividing mechanism in FIG. 1.

FIG. 3 is a perspective view of a second embodiment of an original sheet dividing mechanism according to the present invention.

FIG. 4 is an enlarged side view of a dividing mechanism in FIG. 3.

FIG. 5 is a perspective view of a third embodiment of the original sheet dividing mechanism according to the present invention.

FIG. 6 is an enlarged side view of a dividing mechanism in FIG. 5.

FIG. 7 is a perspective view of a fourth embodiment of the original sheet dividing mechanism according to the present invention.

FIG. 8 is an enlarged side view of a dividing mechanism in FIG. 7.

FIG. 9 is a perspective view showing another cutting method in FIG. 3.

FIG. 10 is an enlarged cross-sectional view of a main part, showing a cutting state in FIG. 9.

### DESCRIPTION OF EMBODIMENTS

Hereinafter, the present invention will be described by means of illustrated embodiments. As shown in FIG. 1, an original sheet dividing apparatus 100 of the present invention generally includes an original sheet supply portion 10, feed-side rollers 20a to 20n, a laser emission device 30, a separating member 40, reception-side rollers 50a to 50n for divided original sheets 1s and 1t, and an original sheet take-up portion 60, and each component is incorporated into an apparatus frame (not shown).

An applied original sheet 1 in FIG. 1 has an active material layer 1a formed on at least one of front and back surfaces of a metal foil 4 by applying an electrode paste thereto. The original sheet 1 has, at both sides of the metal foil 4, regions (referred to as ear portions 1b) where the electrode paste is not applied. Although not shown, there are various types of the original sheet 1, such as a type in which the ear portion 1b is present only at one side, and a type in which no ear portions 1b are present at both sides. A suitable type is selected according to use.

The metal foil 4 is, for example, a copper foil or an aluminum foil. The electrode paste contains an active material, a binder, and a solvent, etc. Examples of the active material include a positive electrode active material and a negative electrode active material.

The positive electrode active material contains, for example, a composite oxide, metal lithium, and sulfur, etc.

The negative electrode active material includes, for example, various carbons, an alkali metal such as lithium and sodium, a metal compound, a metal oxide of SiOₓ, and a boron-added carbon.

As the binder, a resin such as fluorine-containing resin, thermoplastic resin, and imide resin is used.

The original sheet supply portion 10 includes a feed-side servomotor 11 that is a feeding side, an original sheet feed shaft 12 connected to the feed-side servomotor 11, and an original sheet support stand (not shown). The original sheet 1 that is in the form of a roll and is suspended by the original sheet support stand is mounted to the original sheet feed shaft 12 and fed by the feed-side servomotor 11.

Next to the original sheet supply portion 10, the feed-side rollers 20a to 20n are installed. The feed-side rollers 20a to 20n convey the original sheet 1 fed from the original sheet supply portion 10 while keeping the original sheet 1 horizontal, and a roller 20d is incorporated in the middle as a publicly-known original sheet-side dancing roller for adjusting the tension of the original sheet 1 being fed. At the rearmost end of the feed-side rollers 20a to 20n, a pair of upper and lower feed-side rollers 20m and 20n are installed and serve to hold the sent original sheet 1 therebetween from above and below and send the original sheet 1 to a division region for the next process while keeping the original sheet 1 horizontal.

The downstream side of the feed-side rollers 20m and 20n at the rearmost end is the division region for the original sheet 1, and the laser emission device 30 is installed directly above the division region. In the drawing, the single laser emission device 30 is depicted, but a plurality of laser emission devices (not shown) can be installed according to the number of sections into which the original sheet 1 is to be divided. The laser emission device 30 divides the original sheet 1 merely into two sections, and thus a laser beam L thereof only needs to be fixed. However, the laser emission device 30 may be a galvano type laser emission device capable of moving the laser beam L as described later.

In the drawings, an irradiation point of the laser emission device 30 is shown by P. The irradiation point P is set to be close to and immediately rearward of the upper feed-side roller 20m at the rearmost end. The laser beam L may be emitted in a single mode, but a second-fourth harmonic laser (green laser), a picosecond laser, and a femtosecond laser, etc., which have higher output, may be used for reducing thermal effects on the active material.

To assuredly separate the original sheets 1s and 1t from each other, it is important that a portion melted at the irradiation point P is separated before becoming rejoined. For this, it is important that, at the downstream side of the irradiation point P, a moving direction of the one divided original sheet 1s is caused to be upward or downward relative to a moving direction of the other original sheet 1t and the divided original sheets 1s and 1t adjacent to each other at the irradiation point P are vertically separated from each other.

The above case includes a case (FIGS. 5 to 8) where the moving direction of the other original sheet 1t (1s) agrees with the moving direction of the original sheet 1 before division and only the moving direction of the one divided original sheet 1s (1t) is caused to be upward or downward relative to the moving direction of the other original sheet 1t (1s), and a case (FIGS. 1 to 4) where the one divided original sheet 1s (1t) is moved upward relative to the moving direction of the original sheet 1 before division and the other original sheet 1t (1s) is moved downward relative to the moving direction of the original sheet 1 before division.

The separating member 40 may not be used for the vertical separation, and the divided original sheets 1s and 1t may be taken up such that conveying directions of the original sheets 1s and 1t are displaced vertically relative to each other. However, by using the separating member 40 that will be described next, the original sheets 1s and 1t can be assuredly separated from each other.

The separating member 40 may be any member as long as the member vertically separates the original sheets 1s and 1t from each other before a melting material that is melted by the laser beam L at the irradiation point P becomes solidified, thereby preventing rejoining. In later-described examples, a roller or a sliding plate is used. As a matter of course, the separating member 40 is not limited to the roller and the sliding plate as long as the separating member 40 performs the above operation. The separating member 40 is movable toward and away from the irradiation point P so as to be able to change a division angle θ of the divided left and right original sheets 1s and 1t that are separated by the separating member 40.

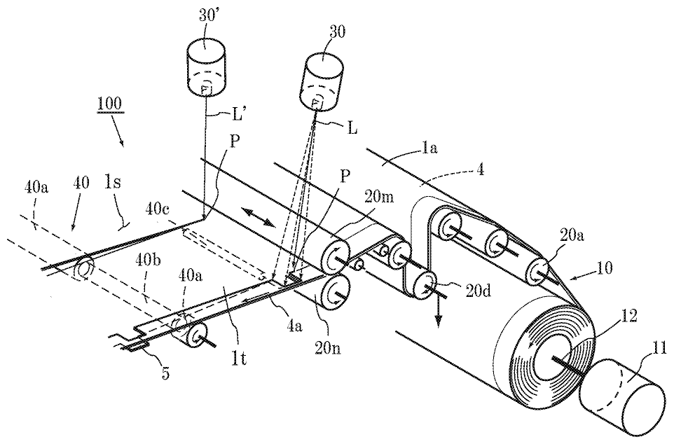

In the former case, as shown in FIGS. 5 and 6, the roller that is the separating member 40 is provided below the one divided original sheet 1s so as to slightly raise the original sheet 1s to make the conveying directions of the adjacent divided original sheets 1s and 1t different from each other. In the case of the drawings, the original sheet 1s is raised, but the original sheet 1t at the opposite side may be raised, or may be pressed down reversely. A separation angle made by cutting is shown by θ (FIG. 6).

FIGS. 7 and 8 show an example in which a roller having different diameters is used as the separating member 40. In this example, a large-diameter portion 40a of the separating member 40 is disposed below the one divided original sheet 1s, and a small-diameter portion 40b of the separating member 40 is disposed below the adjacent other original sheet 1t, so that the conveying directions of the divided original sheets 1s and 1t being conveyed are made different from each other. In the illustrated embodiment, the separating member 40 is disposed below the divided original sheets 1s and 1t. However, reversely, the separating member 40 may be provided above the divided original sheets 1s and 1t so as to press down the divided original sheets 1s and 1t.

FIG. 7 shows an example in which the original sheet 1 is divided into left and right sections at the center thereof, and at the same time, the ear portion 1b is separated from an electrode portion 1a by the large-diameter portion 40a while a tab 5 is cut out from the ear portion 1b.

FIGS. 5 to 8 show the examples in which the roller is used as the separating member 40, but a later-described sliding plate may be used.

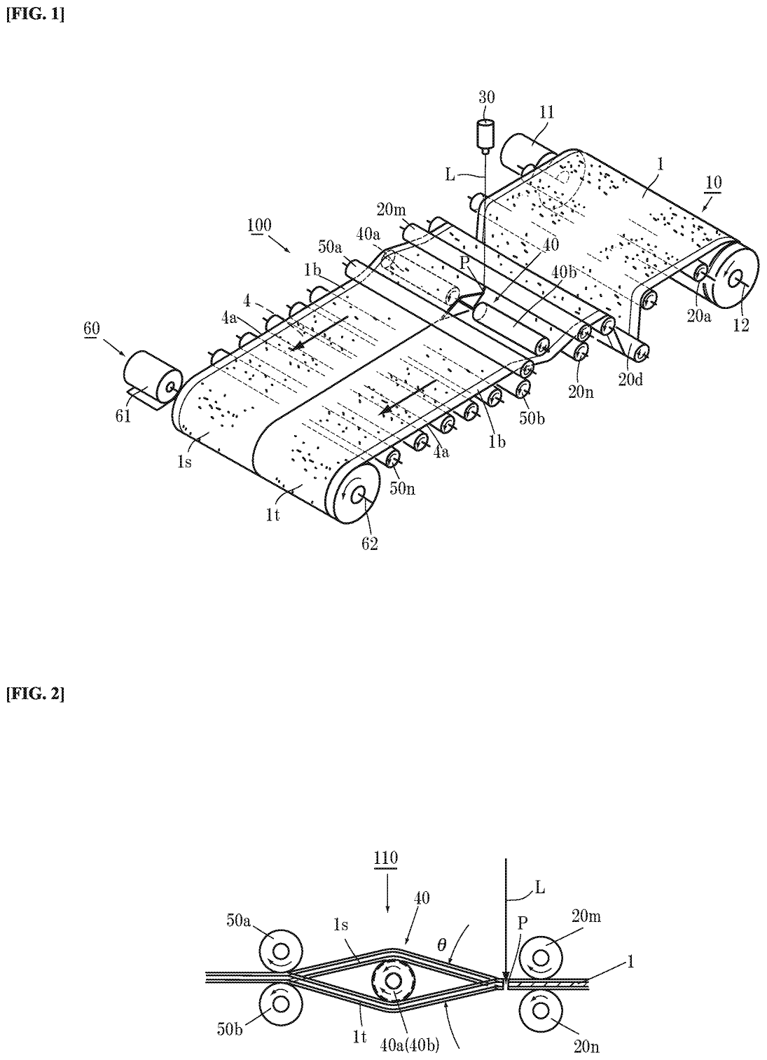

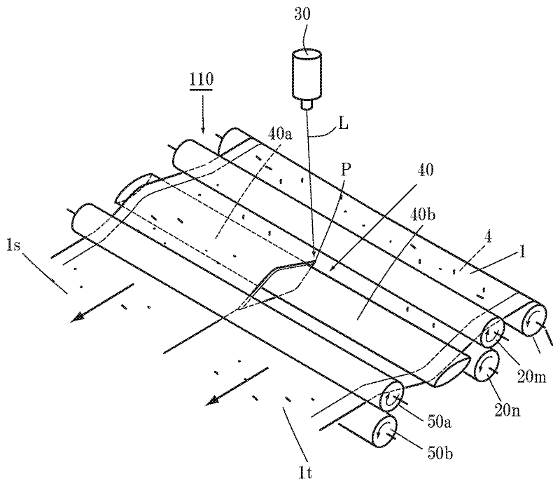

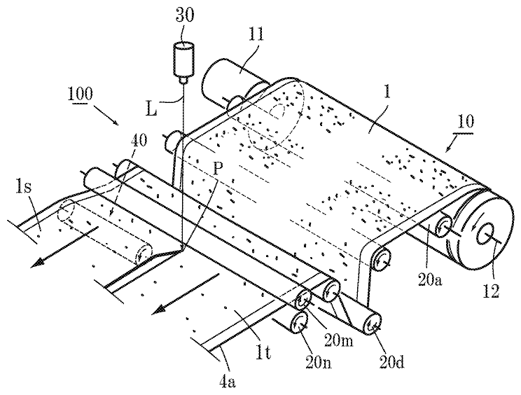

FIGS. 1 to 4 shows examples of the latter case (the case where the divided original sheet 1s (1t) is moved up or down). FIGS. 1 and 2 show an example in which a roller is used as the separating member 40, and FIGS. 3 and 4 show an example in which a sliding plate is used as the separating member 40. The amount of raising and the amount of pressing-down by the separating member 40 in FIGS. 1 to 4 are preferably equal to each other.

In FIGS. 1 and 2, as the separating member 40, a separating roller that is a raising-side member 40a and a separating roller that is a pressing-side member 40b are adjacently and alternately provided. In FIGS. 1 and 2, for easy understanding, the separating rollers 40a and 40b are used as the separating member 40. In the illustrated embodiment, a pair of the left and right separating rollers 40a and 40b are provided. However, a plurality of separating members are provided according to the number of sections into which the original sheet 1 is to be divided.

The left separating roller 40a is configured to be brought into contact with the lower surface of the divided original sheet 1s to raise the divided original sheet 1s. Meanwhile, the right separating roller 40b is configured to be brought into contact with the upper surface of the divided original sheet 1t to press down the divided original sheet 1s. The illustrated separating rollers 40a and 40b are coaxial with each other, and rotate in contact with the divided original sheets 1s and 1t, respectively. Thus, the separating rollers 40a and 40b rotate in the moving direction of the divided original sheets 1s and 1t. The separating rollers 40a and 40b are provided so as to be rotatable in directions opposite to each other.

The illustrated separating rollers 40a and 40b are coaxial with each other. However, as a matter of course, the separating rollers 40a and 40b are not limited thereto, and may be mounted on different shafts so as to be rotatable in directions opposite to each other.

In the case where the number of the divided sections is equal to or larger than 3, adjacent separating rollers are set alternately such that one of the separating rollers raises the divided original sheet and the other separating roller presses down the divided original sheet so as to form a division angle θ between the adjacent divided original sheets. The plate-like separating member 40 in FIGS. 3 and 4 will be described later.

The reception-side rollers 50a to 50n are provided at the downstream side of the separating rollers 40a and 40b. The reception-side rollers 50a to 50n send the divided original sheets 1s and 1t to the original sheet take-up portion 60 while keeping the divided original sheets 1s and 1t horizontal.

In the case where the divided original sheets 1s and 1t are raised and pressed down by the same amount by the separating rollers 40a and 40b as shown in FIGS. 1 to 4, the rollers 50a and 50b provided immediately subsequent to the separating rollers 40a and 40b are a pair of upper and lower rollers in order to locate the original sheets 1s and 1t at the same height at the downstream side of the separating rollers 40a and 40b, so that the divided original sheets 1s and 1t are returned to the same plane.

In the case where, as shown in FIGS. 5 to 8, it is not necessary to return the divided original sheets 1s and 1t to the same height, the divided original sheets 1s and 1t are taken up by different original sheet take-up portions, although not shown.

A take-up-side dancing roller is not installed as one of the illustrated reception-side rollers 50a to 50n in the drawing, but may be provided as necessary.

The original sheet take-up portion 60 is installed subsequent to the reception-side rollers 50a to 50n, and the divided original sheets 1s and 1t are taken up on a take-up shaft 62. A take-up servomotor 61 is connected to the take-up shaft 62 and rotates in synchronization with the feeding servomotor 11.

Next, operation of a first embodiment of the apparatus 100 will be described. The original sheet 1 is mounted on the original sheet feed shaft 12 as shown in FIG. 1. In a drawn portion of the original sheet 1, a portion ahead of the irradiation point P of the laser beam L is divided into two divided original sheets 1s and 1t. The one divided original sheet 1s moves over the left separating roller 40a while the other original sheet 1t moves below the right separating roller 40b, and the original sheets 1s and 1t pass between the reception-side rollers 50a and 50b at the downstream side and are taken up on the take-up shaft 62.

When the apparatus 100 is actuated in this state, the feed-side servomotor 11 operates to feed the original sheet 1 at a predetermined speed. At the same time, the take-up servomotor 61 rotates in synchronization with the feed-side servomotor 11, so that the divided original sheets 1s and 1t are taken up.

In the division region, the laser beam L is emitted from the laser emission device 30 toward the original sheet 1, and the active material and the metal foil 4 of the original sheet 1 instantaneously melt at the irradiation point P. In the present invention, during emission of the laser beam L, assist gas is not sprayed toward the irradiation point P as in the conventional art, and thus the melting material is not blown away and stays at the irradiation point P.

Since the original sheet 1 is continuously fed, the irradiation point P linearly moves in accordance with the movement of the original sheet 1. Owing to the action of the pair of left and right separating rollers 40a and 40b described above, the adjacent divided left and right original sheets 1s and 1t are vertically separated from each other at the irradiation point P simultaneously with the melting. Thus, even when the melting material staying at the irradiation point P becomes solidified at the next moment at which the irradiation point P moves, the melting material cannot become rejoined, and remains at cut end faces and becomes solidified. As a result, the original sheets 1s and 1t are assuredly separated from each other. In addition, at this time, the cut ends are formed by fusion cutting, and the melting material becomes solidified at the cut ends in a round shape due to its surface tension as described above. Accordingly, burrs, which occur as a result of cutting with a blade, do not occur. When the melting material is blown away by assist gas as in the conventional art, the melting material that remains at the cut end faces is pulled by the blown-away melting material and remains as sharp thorns like icicles. However, in the present invention, such a phenomenon does not occur.

Moreover, since the melting material remains at the cut ends in a round shape, cutting dust, which occurs in the case of using assist gas, does not occur.

Since the original sheet 1 is continuously fed, the original sheet 1 is continuously divided as long as the laser beam L is emitted. The divided original sheets 1s and 1t are taken up on the take-up shaft 62 as described above. At this time, a dancing roller may be provided as one of the reception-side rollers 50a to 50n for tension adjustment, although not shown.

Next, a second embodiment will be described (FIGS. 3 and 4). As another example of the separating member 40, as shown in FIG. 3, the separating member 40 is composed of a plate-like member having a cross-section in the feed direction of the original sheet 1, the cross-section having a rhombic shape or a shape similar to a planar shape of a boat. That is, the separating member 40 is formed such that the side thereof close to the irradiation point P is formed in a thin blade shape and the thickness thereof gradually increases toward the opposite side. The center portion of the separating member 40 is thickest, and the thickness of the separating member 40 gradually decreases from the center portion toward the opposite side. A portion (left portion) of the plate-like separating member 40 is configured to be brought into sliding contact with the lower surface of the divided left original sheet 1s to raise the divided original sheet 1s. This portion is a raising portion 40a.

Meanwhile, a right portion of the separating member 40 is configured to be brought into sliding contact with the upper surface of the divided right original sheet 1t to press down the divided original sheet 1s. This portion is a pressing-down portion 40b. The separating member 40 is movable toward and away from the irradiation point P so as to be able to change the division angle θ of the divided left and right original sheets 1s and 1t. Since the separating member 40 is brought into sliding contact with the divided original sheets 1s and 1t as described above, the separating member 40 is preferably a hard resin having a low coefficient of friction (e.g., tetrafluoroethylene resin). The separating member 40 is provided so as to cover the entire length of the original sheet 1, but may be shorter than the width of the original sheet 1 as long as the separating member 40 does not impede feeding of the original sheet 1.

Next, a third embodiment of the present invention will be described with reference to FIGS. 5 and 6. In this case, the single separating member 40 is provided as a roller type separating member 40 below the one divided original sheet 1s in the drawing so as to raise the original sheet 1s. The other divided original sheet 1t is fed with the height thereof maintained. Accordingly, a separation angle θ is formed between the original sheets 1s and 1t. In this case, the original sheet 1s after division is pulled closer to the division region side than the original sheet 1t by an amount by which the original sheet 1s is raised. Thus, the original sheets 1s and 1t are separately taken up. In this case as well, when the number of the divided sections is equal to or larger than 3, separating members 40 are disposed at alternate divided sections.

FIGS. 7 and 8 show a modification of the third embodiment of the present invention, and the separating member 40 is composed of the large-diameter portion 40a and the small-diameter portion 40b that are coaxial with each other, the one divided original sheet 1s is fed so as to move over the large-diameter portion 40a, and the other original sheet 1t is fed so as to move over the small-diameter portion 40b. In the illustrated embodiment, the ear portion 1b is fed so as to move over a large-diameter portion 40a′ provided at an end portion of the separating member 40. In this case, a holding roller 40c for holding the other original sheet 1t is preferably provided at the upstream side of the small-diameter portion 40b. In this case as well, a separation angle θ at which the one original sheet 1s (and the ear portion 1b) and the other original sheet 1t which are adjacent to each other are vertically opened is formed between the original sheets 1s and 1t.

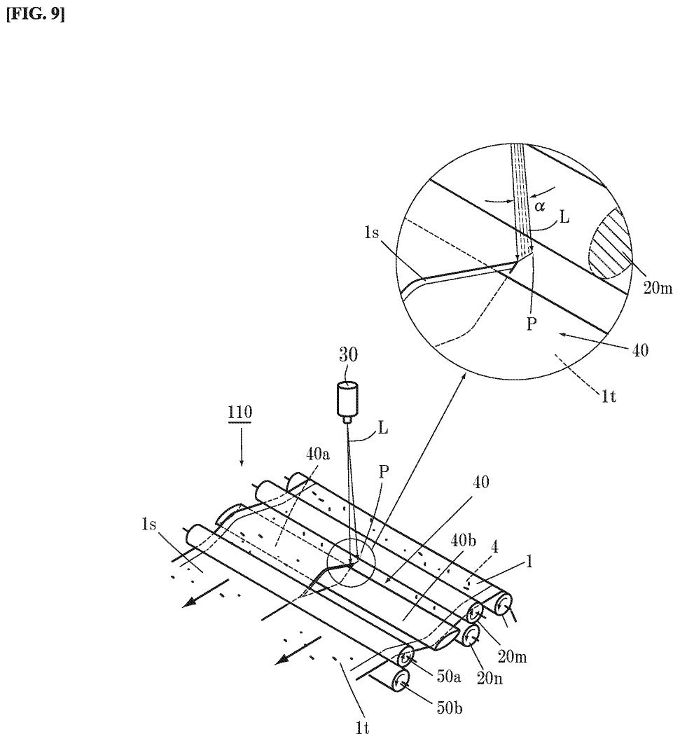

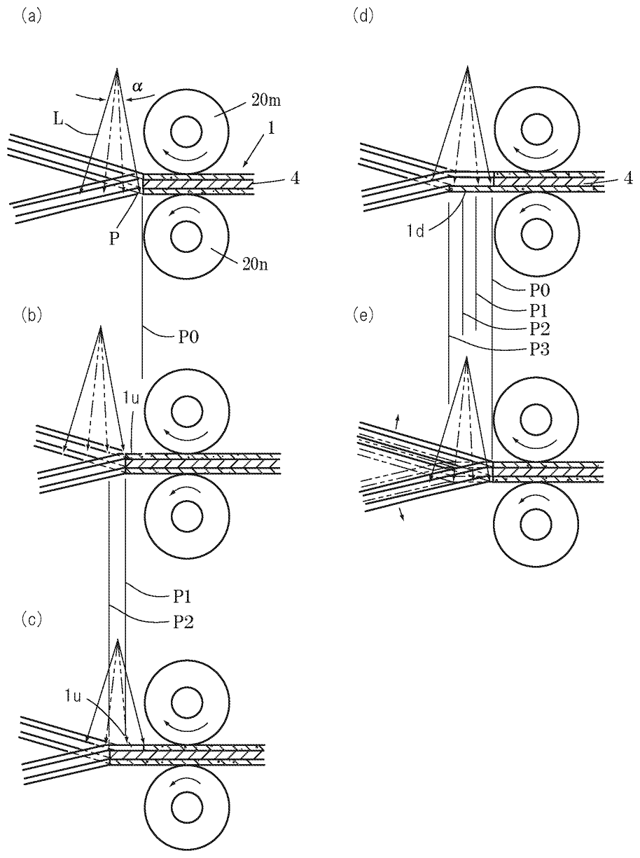

Next, another method for dividing the original sheet 1 of the present invention will be described with reference to FIGS. 9 and 10. In the above case, the laser beam L is fixed, and the original sheet 1 is continuously cut as the original sheet 1 moves. On the contrary, in the case described below, the laser emission device 30 is not a fixed type and is a galvano type, and causes the laser beam L to reciprocate linearly along the feed direction of the original sheet 1 to cut the original sheet 1 (FIGS. 10(a) to 10(e)). For cutting the original sheet 1, the laser emission device 30 adjusts output of the laser beam L and causes the laser beam L to reciprocate a plurality of times to cut the original sheet 1. The reciprocation angle of the laser beam L is shown by α. The apparatus configuration is the same as in FIG. 1.

FIG. 10 (a) shows a time point at which an undivided portion of the original sheet 1 has moved past the final feed-side rollers 20m and 20n and has reached a point P0 that is an entry of the division region. The laser beam L reciprocates with the angle α at the downstream side of the point P0. The divided portions of the original sheet 1 are vertically separated from each other at the irradiation point P by the separating member 40.

FIG. 10 (b) shows a state where the undivided portion of the original sheet 1 has been sent further from the point P0 to a point P1 at the downstream side and a front surface portion 1u of an entry portion of the original sheet 1 has been melted by the reciprocating laser beam L. The output of the laser beam L is reduced. In the case of the present embodiment, the front surface portion 1u is the active material layer. As described above, in addition to the composite oxide, the metal oxide, and various carbons, which are hard to melt, the active material contains a metal and a resin binder, etc., and the metal and the resin binder melt mainly by means of the laser application.

FIGS. 10(c) and 10(d) show a state where the undivided portion of the original sheet 1 has been sent further from the point P1 past a point P2 at the downstream side and the metal foil 4 of the entry portion of the original sheet 1 has been melted by the similarly reciprocating laser beam L until the undivided portion is sent further to a point P3.

FIG. 10 (e) shows a state where the undivided portion of the original sheet 1 has been sent to the final point P3 and the active material layer of a lower surface portion 1d of the original sheet 1 has been melted by the similarly reciprocating laser beam L. The melting material is not blown away by assist gas as in the conventional art. Thus, the melting material remains at the cut end faces and adheres to the end faces in a rounded state due to its surface tension as described above. When the irradiation point P moves, the heat of the melting material is taken by the surroundings and thereby the melting material is quickly cooled, so that the melting material becomes solidified in this state.

Then, when the active material layer of the lower surface portion 1d is melted, the left and right original sheets 1s and 1t are pulled vertically to be separated due to movement of the original sheet 1 toward the separating member 40, simultaneously with the melting, before rejoining of the melting material, so that the original sheet 1 is assuredly cut.

Here, the laser beam L reciprocates along the moving direction of the original sheet 1 with the angle α. When the laser beam L reciprocates at a constant angular velocity (the running speed on the original sheet 1 is also substantially the same speed), while the laser beam L moves in the same direction as the moving direction of the original sheet 1, the relative speed of the laser beam L to the original sheet 1 is decreased by the moving speed of the original sheet 1, and energy inputted by the applied laser beam L increases, so that the original sheet 1 is fusion-cut thin; and, on the other hand, while the laser beam L moves in a direction opposite to the moving direction of the original sheet 1, the relative speed of the laser beam L to the original sheet 1 is increased by an amount corresponding to the movement of the original sheet 1, and the energy inputted by the applied laser beam L decreases, so that the melting material is heated and shaped to be rounded. Accordingly, cleaner cut faces can be obtained.

The output of the laser emission device 30 can be freely changed by a program. Thus, it is possible to make the output for the active material layer different from that for the metal foil 4, and it is possible to cause the laser beam L to run on the cutting line in zigzag or while drawing a loop, although not shown. This point is applicable to the case where the laser beam L is not caused to reciprocate along the moving direction of the original sheet 1 as described above. That is, the laser beam L can be caused to zigzag or draw a loop by swinging the laser beam L laterally relative to the irradiation point P. Accordingly, the melting width of the irradiation point P can be increased.

As described above, by vertically spreading the melted original sheet 1 at the irradiation point P of the laser beam L, rejoining at the time of solidification of the melting material can be physically avoided, and the original sheet 1 can be assuredly divided while running.

### REFERENCE SIGNS LIST

1 original sheet

1a active material layer (electrode portion)

1b ear portion

1d lower surface portion

1s, 1t divided original sheet

1u front surface portion

4 metal foil

5 tab

10 original sheet supply portion

11 feeding servomotor

12 original sheet feed shaft

20a to 20n feed-side roller

20d original sheet-side dancing roller

30 laser emission device

40 separating member

40a, 40a′ raising-side member (roller, portion, large-diameter portion)

40b pressing-side member (roller, portion, small-diameter portion)

40c holding roller

50a to 50n reception-side roller

60 original sheet take-up portion

61 take-up servomotor

62 take-up shaft

100 original sheet dividing apparatus

110 dividing mechanism

L laser beam

P irradiation point

θ separation angle

α oscillation angle of laser beam

1. An original sheet dividing method for cutting an original sheet having an active material layer applied to at least one surface of a long metal foil, with a laser beam in a longitudinal direction, the original sheet dividing method comprising:
continuously moving the original sheet while applying the laser beam to the original sheet to melt the original sheet at an irradiation point;
causing a moving direction of one divided original sheet to be upward or downward relative to a moving direction of another divided original sheet at a downstream side of the irradiation point; and
vertically separating the divided original sheets adjacent to each other at the irradiation point.

2. The original sheet dividing method according to claim 1, wherein the original sheet is cut while the laser beam is caused to reciprocate along a running direction of the original sheet.

3. The original sheet dividing method according to claim 1, wherein
a separating member is disposed at the downstream side of the irradiation point, and
the one divided original sheet is caused to move over the separating member or pass below the separating member to make the moving direction of the one divided original sheet different from the moving direction of the other original sheet.

4. An original sheet dividing mechanism for cutting a running original sheet having an active material layer applied to at least one surface of a long metal foil, with a laser beam in a longitudinal direction, the original sheet dividing mechanism comprising:
a laser emission device disposed above the original sheet and configured to apply the laser beam to the original sheet to divide the original sheet; and
a separating member disposed at a downstream side of an irradiation point of the laser beam so as to be in contact with a lower surface of one divided original sheet and configured to raise the divided original sheet, or disposed at the downstream side of the irradiation point of the laser beam so as to be in contact with an upper surface of another divided original sheet and configured to press down the divided original sheet, thereby to make a moving direction of the one divided original sheet different from a moving direction of the other divided original sheet.

5. An original sheet dividing mechanism for cutting a running original sheet having an active material layer applied to at least one surface of a long metal foil, with a laser beam in a longitudinal direction, the original sheet dividing mechanism comprising:
a laser emission device disposed above the original sheet and configured to apply the laser beam to the original sheet to divide the original sheet; and
a separating member including a raising-side member disposed at a downstream side of an irradiation point of the laser beam so as to be in contact with a lower surface of one divided original sheet and configured to raise the divided original sheet and a pressing-side member disposed at the downstream side of the irradiation point of the laser beam so as to be in contact with an upper surface of another divided original sheet and configured to press down the divided original sheet, the separating member being configured to make a moving direction of the one divided original sheet different from a moving direction of the other divided original sheet.

6. The original sheet dividing mechanism according to claim 4, wherein the separating member is provided so as to move toward and away from the irradiation point.

7. The original sheet dividing mechanism according to claim 4, wherein the separating member is composed of a roller configured to rotate in contact with the divided original sheets.

8. The original sheet dividing mechanism according to claim 4, wherein the separating member is composed of a plate member having a cross-section parallel to a running direction of the original sheet, the cross-section having a thickness that gradually decreases as distance to an irradiation point side decreases.

9. An original sheet dividing apparatus for cutting a running original sheet having an active material layer applied to at least one surface of a long metal foil, with a laser beam in a longitudinal direction, the original sheet dividing apparatus comprising:
an original sheet supply portion configured to continuously feed the original sheet;
a laser emission device disposed above the fed original sheet and configured to apply the laser beam to the original sheet to divide the original sheet;
a separating member disposed at a downstream side of an irradiation point of the laser beam so as to be in contact with a lower surface or an upper surface of at least one divided original sheet and configured to raise or press down the divided original sheet thereby to make a moving direction of the one divided original sheet different from a moving direction of another divided original sheet; and
an original sheet take-up portion disposed at a downstream side of the separating member and configured to take up the divided original sheets.
